(19) United States
(12) Patent Application Publication
(10) Pub. No.: US 2007/0169966 A1
(43) Pub. Date: Jul. 26, 2007

(54) Off-road vehicle comprising ambulatory limbs

(75) Inventor: Josef Konrad, Preitenegg (AT)

Correspondence Address: YOUNG & THOMPSON, 745 SOUTH 23RD STREET, 2ND FLOOR, ARLINGTON, VA, 22202, US

(73) Assignee: Bim Kemi AB, Stenkullen (SE)

(21) Appl. No.: 10/555,777

(22) PCT Filed: May 6, 2004
(86) PCT No.: PCT/AT04/00156

§ 371 Date: Nov. 2, 2006

(30) Foreign Application Priority Data
May 7, 2003 (AT) A 683/2003

(51) Int. Cl. B62D 51/06

(52) U.S. Cl. 180/8.3

(57) ABSTRACT

An off-road vehicle includes ambulatory limbs, a vehicle frame (2), a drive assembly (9) and an axle structure having two wheels or chain driving mechanisms. The vehicle frame (2) consists essentially of two parallel, telescopic tubing lengths that run approximately parallel to the terrain, each length being composed of a fixed tube (5) and a displaceable tube (3). The free end of the displaceable tube (3) is equipped with a respective bearing element (4), which is rotatably mounted about a bearing point (10) on the plane of the longitudinal axis of the telescopic tubing length.

The invention relates to a vehicle with a vehicle frame, a drive assembly, an axle structure with wheels or tracked running gear and with pipes which can telescope roughly parallel to the subsoil and which are each composed of a fixed pipe and a movable pipe, on the free end of the movable pipes there being one support element each.

AT 292581 discloses a generic excavator which stands on the ground on the one hand by way of wheels and on the other by way of support feet. The support feet can be telescopically lengthened and shortened by hand.

U.S. Pat. No. 3,335,809 A discloses a vehicle for earth-moving operations which stands on the ground by way of four wheels. Two vehicle frame parts on which the wheels and wheel axles are located are connected to one another by way of a hydraulically driven middle part which can be telescopically lengthened. Furthermore, support elements are assigned to the wheels and can be pivotally supported on the respective vehicle part.

These and other known walking vehicles have the disadvantage that due to the arrangement of the walking members and the pertinent hydraulic elements the vehicle cannot easily progress with a constant speed and thus another vehicle is necessary for transport, for example for more rapid advance of the vehicle, for example for transfer at the job site in rough terrain. By the arrangement of several hydraulic cylinders the walking members can be alternately raised, lowered and moved, but the operator must operate very many actuation elements in order to achieve only a slight advance motion of the vehicle.

Thus the object of the invention is to eliminate this defect and to propose an all-terrain vehicle of the indicated type which is also suitable for uniform progress in the range from for example 0 to 5 km/h. A higher speed should also be reached on road-like subsoil.

The object is achieved in a generic vehicle in that the vehicle frame consists essentially of two pipes which can be telescoped roughly parallel to the subsoil and which are arranged parallel to one another and form walking members, that the movable pipes can be extended and retracted mechanically or hydraulically in alternation or at the same time in the fixed pipes, and that the support elements are supported in the plane of the lengthwise axis of the telescoping pipe to be able to pivot around a bearing point.

By providing pipes which can be telescoped parallel to the subsoil, it is possible to achieve an advance motion over a larger displacement path. When one pipe is extended and the other pipe is retracted in alternation, retraction should take place with a higher speed than extension. When the pipe is retracted, the support element is lowered, at the same time anchored by way of a support plate or a wheel in the subsoil, and the pipe is extended again. There is thus always three-point support of the vehicle during progressive movement.

For uniform progression on subsoil which is not too steep, for example a roadway, it can also be provided that on at least one support element a free-running and lockable or driven wheel or a track is mounted which can optionally be steered.

The vehicle is driven in this case by means of a drive and steerable axle.

The axle structure can have wheels or tracks in the area of the free end of the fixed pipes, within the framework of the invention.

An axle structure which is located articulated on the fixed pipes offers the advantage that the vehicle can also be positioned roughly horizontally even on slopes transversely to the existing incline of the slope.

In one preferred embodiment of the invention it can be provided that the angular speed of the wheels or the drive speed of the tracks and the walking speed of the walking elements, i.e. the movable pipes and support elements, can be matched to one another by means of connectable control electronics.

With connectable control electronics it is possible to match the motion of the walking members to the angular velocity of the driven axle such that uniform forward motion can be achieved without burdening the vehicle driver with the handling of several actuating elements. The vehicle can thus achieve a uniform speed.

The arrangement of a superstructure which is articulated on the free ends of the fixed pipes allows the vehicle to be easily provided with a driver's cab and a crane jib on which for example a harvester head or a drag can be mounted. The articulated arrangement of the superstructure, as in the articulated axle structure, allows horizontal alignment of the driver's cab and mainly the crane jib in rough terrain; this ensures much simpler operation of the working machinery.

The use of square profiles for the telescoping pipes is advantageous since in this way a simple and stable structure of the undercarriage and a flat surface are achieved. Thus no additional structural element is necessary for the arrangement for example of the drive assembly or of the crane.

The subject matter of the invention is shown by way of example in the drawings.

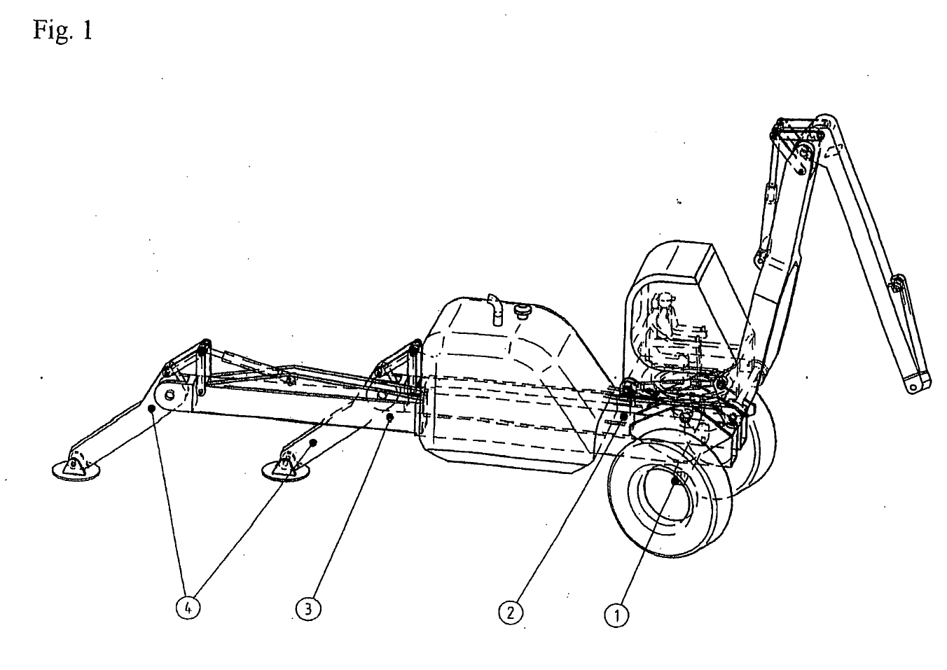

FIG. 1 shows an oblique view of the vehicle,

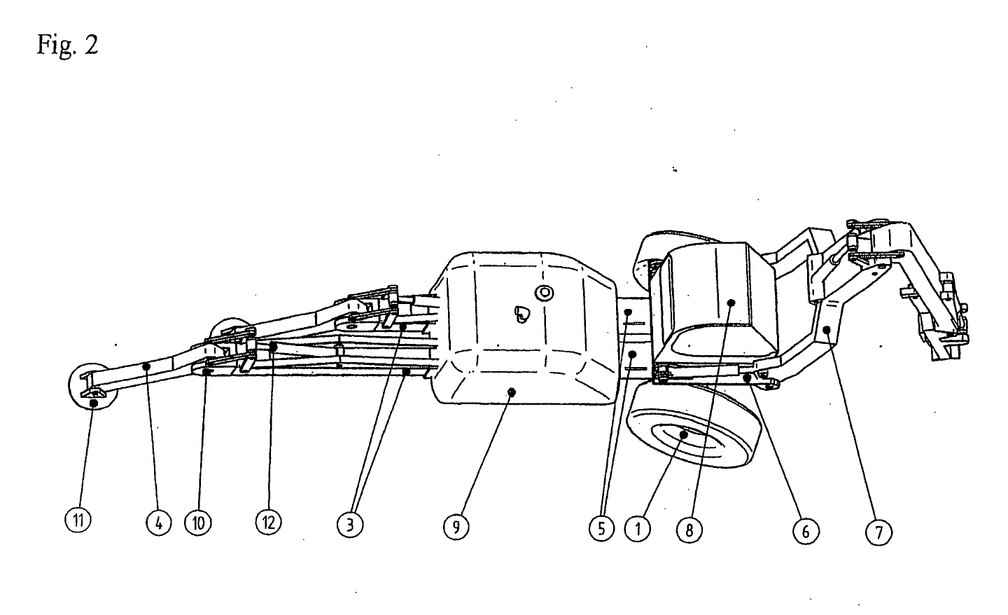

FIG. 2 shows an overhead view of the vehicle,

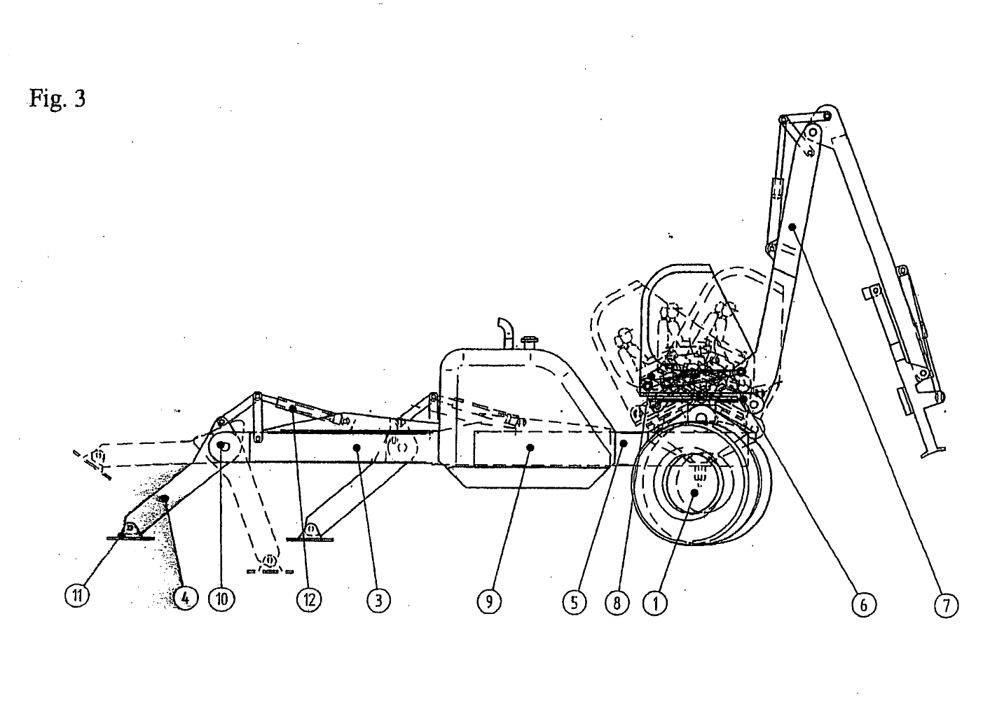

FIG. 3 shows a side view of the vehicle,

FIG. 4 shows the vehicle equipped with a harvester head in flat terrain,

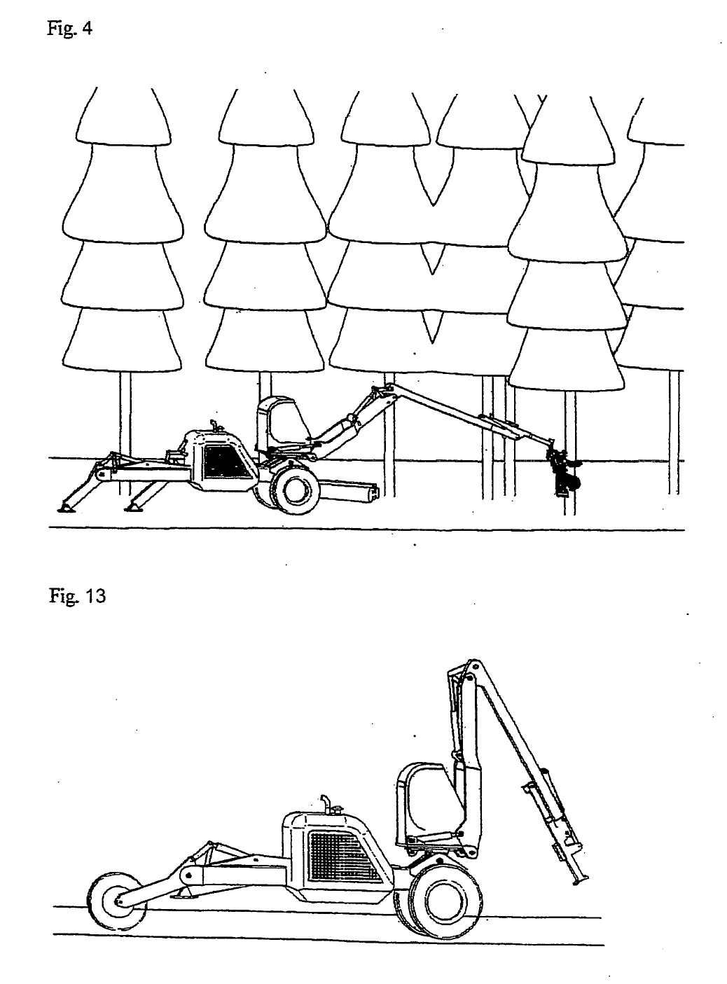

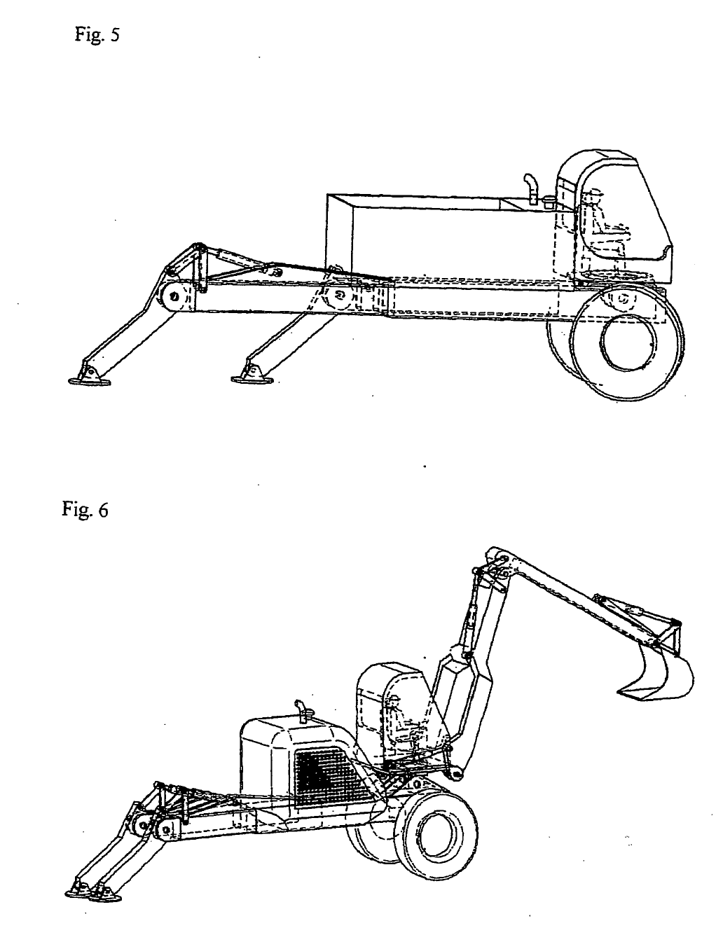

FIG. 5 shows the vehicle equipped with a handling platform,

FIG. 6 shows the vehicle equipped with a drag and extended telescoping pipes,

FIGS. 7 to 10 show the vehicle when an obstacle is being crossed,

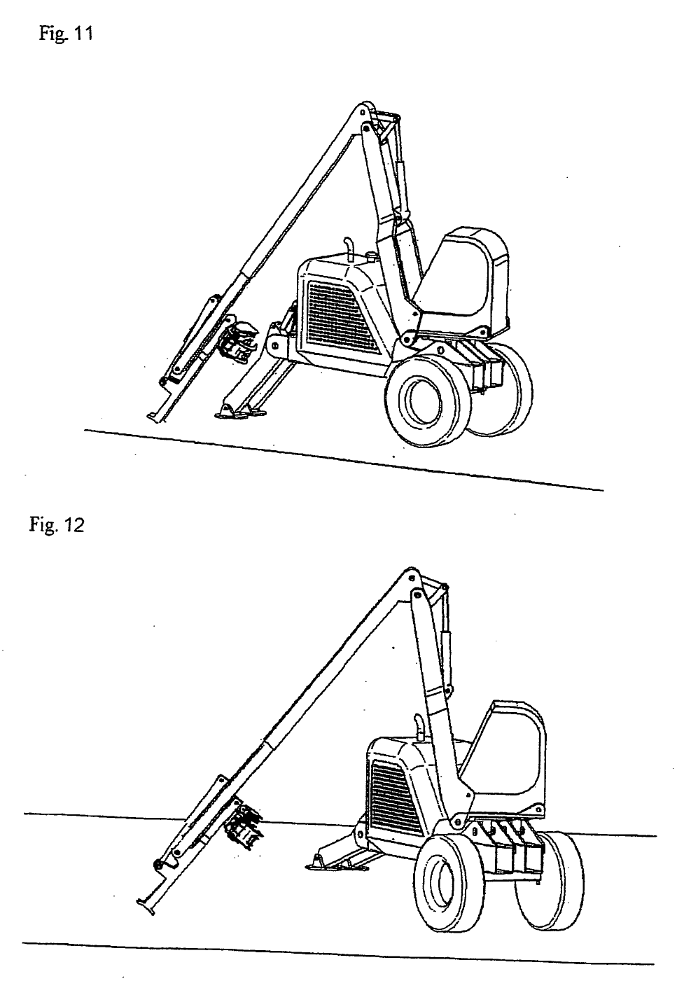

FIGS. 11 and 12 show rotary motion of the vehicle with support by the crane jib and

FIG. 13 shows the vehicle with wheels when travelling on flat roadway.

FIGS. 1 to 3 show that the frame 2 of the vehicle consists essentially of two telescoping pipes which are each composed of a fixed pipe 5 and a movable pipe 3. Square profiles are used for the pipe elements. The movable pipes 3 are moved hydraulically or mechanically in the two fixed pipes 5, at the same time or in alternation, linearly forward or backward.

On the free end of the movable pipes 3 there is one support element 4 each which is mounted in the plane of the lengthwise axis of the telescoping pipe to pivot around a bearing point 10. The support elements 4 can be raised or lowered by means of hydraulic cylinders 12 and support plates 11 which engage the subsoil are mounted on the support elements 4. FIG. 13 shows that in place of the support plates 11 on at least one support element 4 a wheel or a track can be mounted in order to enable progressive motion with higher speed on roughly flat, road-like subsoil.

When moving with movable pipes 3 which are being extended and retracted in alternation the support element 4 is blocked during extension and the vehicle is moved parallel. During retraction which takes place at the same time somewhat more rapidly during extension of the other movable pipe 3, the support element 4 is slack and can thus be pulled over obstacles or relief or can also be raised by means of the hydraulic cylinder 12. After the movable pipe 3 is retracted, the support element 4 is set down for extension, fixed with the support plate 11 and again extended with simultaneous retraction of the other movable pipe 3. With this construction not only is a uniform speed ensured, but a uniform height of the frame over the subsoil is also ensured by the parallel displacement of the movable pipe 3.

On the vehicle frame 2 the axle structure—with two wheels or tracked running gear—is arranged fixed or articulated in the area of the free end of the fixed pipes 5. The axle structure can have a driven or freely running steered axle 1. By means of connectable control electronics the angular speed of the axle 1 and the walking speed of the walking elements, i.e. the movable pipes 3 and the support elements 4, can be matched to one another.

A superstructure 6 is articulated to the two fixed pipes 5 by way of the axle structure. The configuration of the superstructure 6 leaves open all possible versions so that it can be equipped with a crane jib 7 and/or a driver's cab 8. On the crane jib 7, as shown for example in FIGS. 4 to 6, a drag or a harvester head can be mounted. On the end of the fixed pipes 5 which is opposite the free end is the drive assembly 9 which however can also be integrated into the cab structure. Auxiliary devices, such as a handling platform as shown in FIG. 5, can also be mounted on the vehicle frame 2.

The superstructure 6 is connected above the axle structure to the vehicle frame 2 fixed or by means of a rim bearing. The articulated support of the axle structure and/or of the superstructure 6 allows horizontal positioning of the vehicle or of the driver's cab 8 on a precipitous incline.

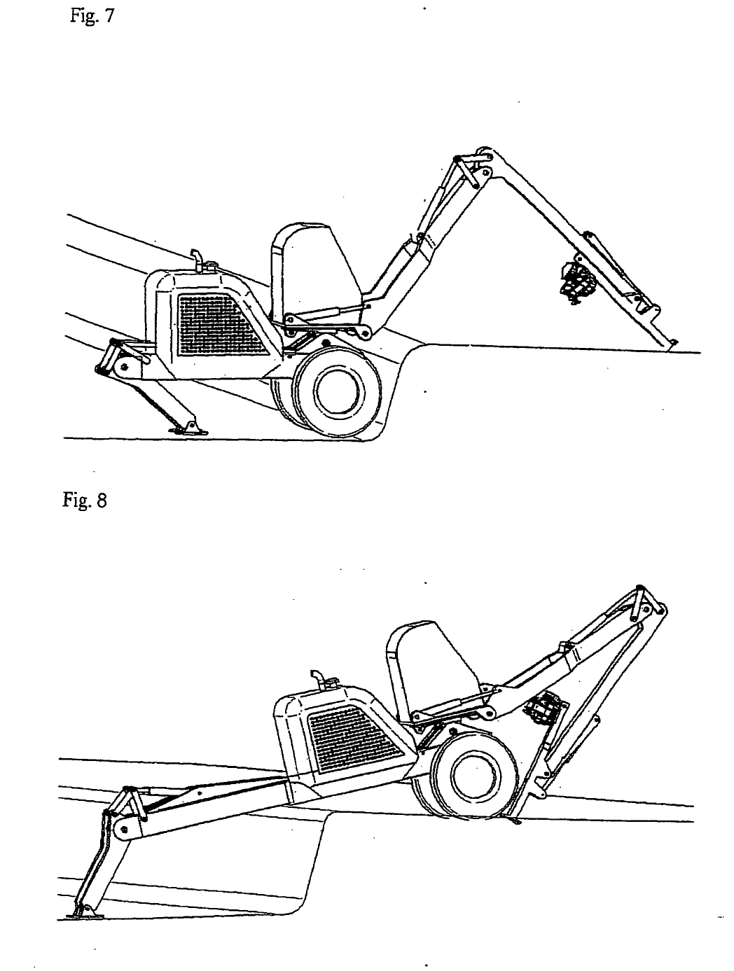

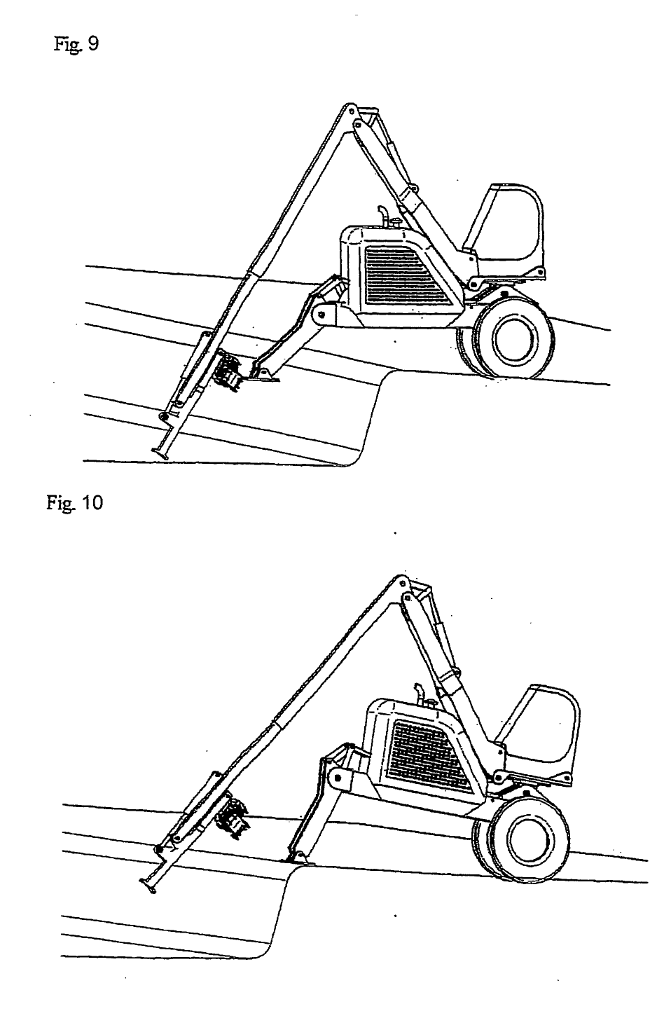

FIGS. 7 to 10 show how with the vehicle as claimed in the invention an obstacle in the form of a terrace is crossed. First, the support elements 4 are positioned or aligned in the direction to the vehicle front and the extended crane jib 7 is supported on the terrace (FIG. 7). Then, by means of the crane jib 7 the vehicle is raised over the terrace, for support the movable pipes 3 being extended (FIG. 8). Afterwards the superstructure 6 with the crane jib 7 is turned by 180°, the crane jib 7 is set down behind the terrace and the vehicle is raised to the rear, by which the support elements 4 lift off the subsoil (FIG. 9). After retracting the movable pipes 3, the support elements 4 are positioned on the terrace with the support plates 11 (FIG. 10) and the superstructure is again turned back by 180°.

FIGS. 11 and 12 describe the process of turning the vehicle by 90° with the axle 1 fixed. With the superstructure 6 aligned roughly to the rear of the vehicle the crane jib 7 is positioned roughly in the area of the support elements 4. By extending the crane jib 7 the back of the vehicle is raised and by turning the superstructure 6 relative to the vehicle frame 2 the vehicle is turned by the desired angle (FIG. 11). Then the support elements 4 (FIG. 12) are simply put down and the vehicle is ready to travel again in the new direction. This turning can be undertaken by any optional angle.

1. All-terrain vehicle with a vehicle frame, a drive assembly, an axle structure with wheels or tracked running gear and with pipes which can telescope roughly parallel to the subsoil and which are each composed of a fixed pipe (5) and a movable pipe (3), on the free end of the movable pipes (3) there being one support element (4) each, characterized in that the vehicle frame (2) consists essentially of two pipes which can be telescoped roughly parallel to the subsoil, which are arranged parallel to one another and form walking members, that the movable pipes (3) can be extended and retracted mechanically or hydraulically in alternation or at the same time in the fixed pipes (5), and that the support elements (4) are supported in the plane of the lengthwise axis of the telescoping pipe to be able to pivot around a bearing point (10).

2. Vehicle as claimed in claim 1, wherein the support elements (4) can be raised or lowered or enabled by means of hydraulic cylinders (12).

3. Vehicle as claimed in-claim 1, herein support plates (11) which engage the subsoil are mounted on the support elements (4).

4. Vehicle as claimed in claim 1, wherein on at least one support element (4) a free-running and lockable or driven wheel or a track is mounted which can optionally be steered.

5. Vehicle as claimed in claim 1, wherein the pertinent support element (4) can be raised during retraction of the movable pipe (3) or can be pulled behind over the subsoil.

6. Vehicle as claimed in claim 1, wherein the retraction speed of the movable pipes (3) is greater than their extension speed.

7. Vehicle as claimed in claim 1, wherein the axle structure has wheels or tracks in the area of the free end of the fixed pipes (5).

8. Vehicle as claimed in claim 1, wherein the axle structure is movably connected to the fixed pipes (5).

9. Vehicle as claimed in claim 1, wherein the axle structure has a steerable axle (1).

10. Vehicle as claimed in claim 9, wherein the axle (1) is freely running.

11. Vehicle as claimed in claim 1, wherein the axle (1) is driven.

12. Vehicle as claimed in claim 11, wherein the angular speed of the wheels (1) or the drive speed of the tracks and the walking speed of the walking elements, i.e. the movable pipes (3) and support elements (4), can be matched to one another by means of connectable control electronics.

13. Vehicle as claimed in claim 12, wherein a constant speed of progression can be achieved by means of the control electronics during walking.

14. Vehicle as claimed in claim 1, wherein a superstructure (6) is located articulated in the area of the free end of the fixed pipes (5).

15. Vehicle as claimed in claim 14, wherein there is a driver's cab (8) on the superstructure (6).

16. Vehicle as claimed in claim 14, wherein there is a crane jib (7) on the superstructure (6).

17. Vehicle as claimed in claim 16, wherein a harvester head, a drag, or other devices can be mounted on the crane jib (7).

18. Vehicle as claimed in claim 1, wherein a handling platform or auxiliary devices are attached to the vehicle frame (2).

19. Vehicle as claimed in-claim 2 herein support plates (11) which engage the subsoil are mounted on the support elements (4).

20. Vehicle as claimed in claim 15, wherein there is a crane jib (7) on the superstructure (6).
